(19) United States
(12) Patent Application Publication
(10) Pub. No.: US 2013/0135314 A1
(43) Pub. Date: May 30, 2013

(54) ANALYSIS METHOD

(71) Applicant: David Lamb, Liverpool (GB)

(72) Inventors: John Haggerty, Wirral (GB); David Lamb, Liverpool (GB)

(73) Assignee: LIVERPOOL JOHN MOORES UNIVERSITY, Liverpool (GB)

(21) Appl. No.: 13/395,398

(22) PCT Filed: Sep. 8, 2010
(86) PCT No.: PCT/GB10/01700

§ 371 Date: Sep. 26, 2012

Related U.S. Application Data
(60) Provisional application No. 61/241,156, filed on Sep. 10, 2009.

(51) Int. Cl. G06T 11/20

(52) U.S. Cl. CPC G06T 11/20
USPC 345/440

(57) ABSTRACT

A computer implemented method for analysing communication between a plurality of individuals. The method comprises reading data representing communications involving a first individual from a data store. A network of the communications between the first individual and a plurality of other individuals is displayed. In the displayed network, each individual is represented by a node and communication between individuals is represented by a link between nodes.

The present invention relates to a computer implemented method for analysing communication between a plurality of individuals.

Recent increases in the popularity of networked personal computers has led to email becoming one of the principal media used for communication, and for the dissemination of information, between individuals.

The ubiquity of email as a method of communication means that analysis of a suspect's email messages is now an important source of information in criminal investigations. Further, individuals involved in group-related criminal activity such as the dissemination of indecent images, terrorism and fraud will often use email to communicate with one another.

A number of challenges are faced in forensic investigations which involve email. The generally large volumes of email sent and received by an individual makes analysis of that individual's emails laborious and time consuming using existing tools and techniques. In addition, where a suspect is part of an ongoing investigation, tight time constraints for analysis of email accounts are common. These problems are exacerbated in cases involving a plurality of computers. There is therefore a need for tools which can accurately and efficiently analyse this growing volume of evidential data.

Generally, computer forensics tools are used by analysts to recreate files and data from a suspect's computer and may be used to recreate the suspect's email messages. An analyst may then manually view the messages recreated by the computer forensics tool to determine if their content is relevant to a current investigation.

While analysing a particular suspect's emails may indicate with whom that suspect communicates, such analysis is typically time consuming and inefficient.

It is an object of embodiments of the present invention to obviate or mitigate one or more of the problems outline above.

According to a first aspect of the present invention, there is provided a computer implemented method for analysing communication between a plurality of individuals, the method comprising: reading data representing communications involving a first individual from a data store; and displaying a representation of the communications between the first individual and a plurality of other individuals, wherein, in said representation, each individual is represented by a node and communication between individuals is represented by a link between nodes.

In this way the first aspect of the invention allows data to be read from a data store and a representation of communications indicated by that data to be provided to a user. The representation comprises nodes connected by links, and the representation may therefore take the form of a graph. Components of the graph may be represented so as to allow relationships between the individuals (and the strengths of those relationships) to be readily appreciated by a user.

Each node may be represented in a manner determined by a number of communications in which the individual represented by that node is involved. The number of communications used to determine representation of a node may be a number of communications involving the individual represented by that node which were initiated by another of said plurality individuals. For example, the individual initiating an email communication is the sender of the email. Representation of a node may therefore be based upon a number of emails sent to an individual represented by that node.

The number of communications used to determine the representation of a node may be a number of communications initiated by the individual represented by that node. For example, representation of a node may be based upon a number of emails sent by an individual represented by that node.

A node may be represented in a manner determined by an amount of data present in communications in which the individual represented by that node is involved, a number of individuals with whom the individual represented by that node communicates, or a combination of such factors.

Representation of a link between two nodes may indicate a number of communications between individuals represented by those nodes. For example the thickness of lines representing links may indicate the number of communications between individuals represented by nodes between which the links extend.

Representation of nodes and links between nodes may indicate a time at which communications were sent between individuals represented by those nodes. Representation of nodes and links may be annotated or animated to reflect the times at which communications were sent between individuals represented by those nodes.

The method may further comprise obtaining data representing communication involving each of said plurality of individuals; and displaying a network of the communications between each of said plurality of individuals, wherein each individual is represented by a node and communication between individuals is represented by a link between nodes. That is, the methods may be used to represent communications between individuals other than the first individual.

While the methods may be based solely upon communications involving a single individual and other individuals with whom that individual communicates, the methods may also be based upon communications involving a plurality of individuals (that is communications in which the first individual is not a party may also be taken into account).

Displaying a network may comprise displaying only those nodes representing individuals who have initiated a communication with at least one other of said plurality of individuals. Displaying a network may comprise displaying only those nodes representing individuals who are associated with a communication initiated by at least one other of said plurality of individuals.

The communications may be selected from a group comprising emails, telephone communications, simple messaging service messages, multimedia messaging service messages and websites' internal messaging services. Indeed, the methods described herein can be generally applied to any communications platform. .

Reading data may comprise reading emails from a data store storing emails and the method may further comprise processing each of said emails to generate a plurality of email objects and address objects, each of said address objects representing a respective email address and each of said email objects representing an email between two of said respective email addresses. The nodes may represent the address objects and the links between nodes may represent the email objects.

Generating address objects may comprise generating a single address object for each unique email address.

At least one of said emails in said data store may comprise a reference to a further email, the further email not itself being stored in said data store, and reference identifying a sender and receiver of said further email. Processing each of said emails may further comprise processing the further emails. For example, the further emails may be ‘forwarded’ emails which are quoted in the body of an email stored in the data store. That is, the reference may take the form of textual data included in an email stored in the data store.

According to a second aspect of the present invention, there is provided a method for analysing communication between a plurality of individuals, the method comprising: analysing communication between the plurality of individuals using a first communication platform to generate first data; analysing communication between the plurality of individuals using a second communication platform to generate second data; and generating third data based upon said first data and said second data, said third data indicating relationships between said plurality of individuals.

In this way, analysis can be carried out which is not limited to a single communication platform but which can instead take into account a variety of communications platforms used by an individual of interest. In this way, a more rounded picture of communications between particular individuals can be obtained.

The method may further comprise generating a visualisation of said third data wherein each individual in said plurality of individuals is represented by a node and communication between individuals is represented by a link between nodes. The visualisation may be displayed.

A node may be represented in a manner determined by a number of communications in which the individual represented by that node is involved. The number of communications may be a number of communications in which the individual represented by that node is involved which were initiated by another of said plurality individuals. The number of communications may be a number of communications initiated by that individual.

Representation of a node may be determined by an amount of data present in communications in which the individual represented by that node is involved.

Representation of a node may be determined by a number of individuals with whom the individual represented by that node communicates.

Representation of a link between two nodes may indicate a number of communications between individuals represented by those nodes.

The third data may comprise data indicating relationships only between individuals who have initiated communications with at least one other of said plurality of individuals. Further, the third data may comprise data indicating relationships only between individuals who are involved in communications initiated by at least one other of said plurality of individuals.

The first and second communication platforms may take any suitable form. For example, both the first and second communication platforms may be any one of email, landline telephone, mobile telephone, simple message service messages, multimedia message service messages or messages sent using a website's internal messaging system. The first and second communication platforms may be different communication platforms. For example, the first communication platform may be an email and the second communication platform may be telephone.

Embodiments described above in connection to one aspect of the present invention may be used in conjunction with other aspects of the present invention.

It will be appreciated that aspects of the invention can be implemented in any convenient form. For example, the invention may be implemented by appropriate computer programs which may be carried out appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention.

Embodiments of the present invention are now described, by way of example, with reference to the accompanying drawings, in which:

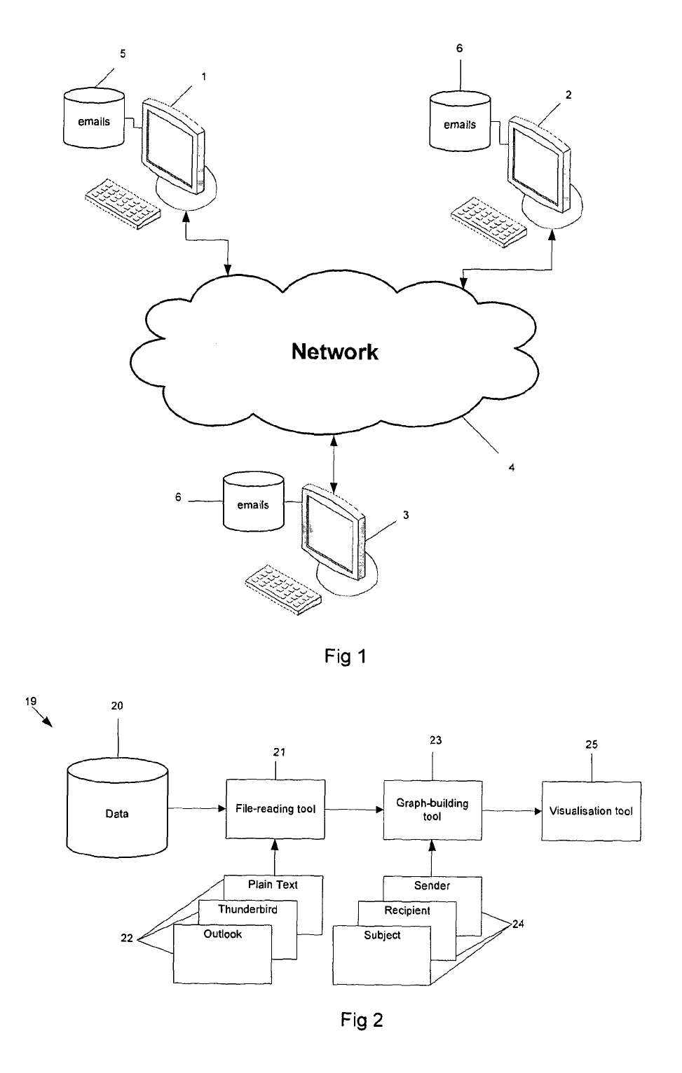

FIG. 1 is a schematic illustration of three computers connected via a computer network;

FIG. 2 is a schematic illustration of a system suitable for use in analysing a social network according to an embodiment of the present invention;

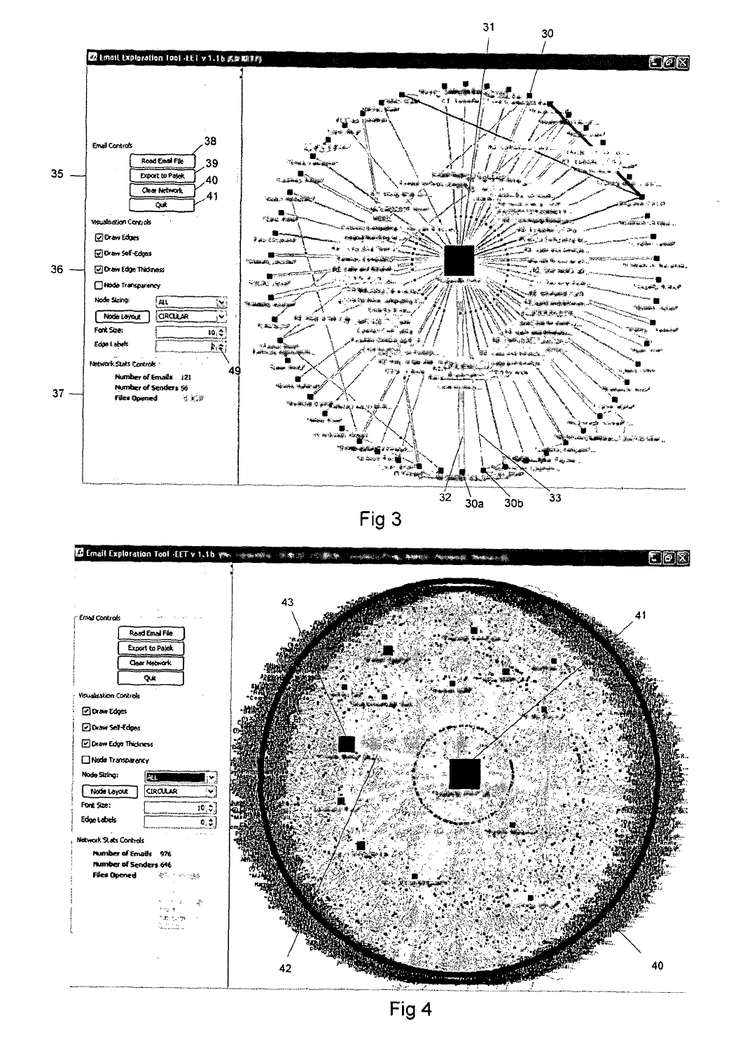

FIG. 3 is a visualisation of a social network generated using the system of FIG. 2;

FIG. 4 is a further visualisation of a social network generated using the system of FIG. 2; and

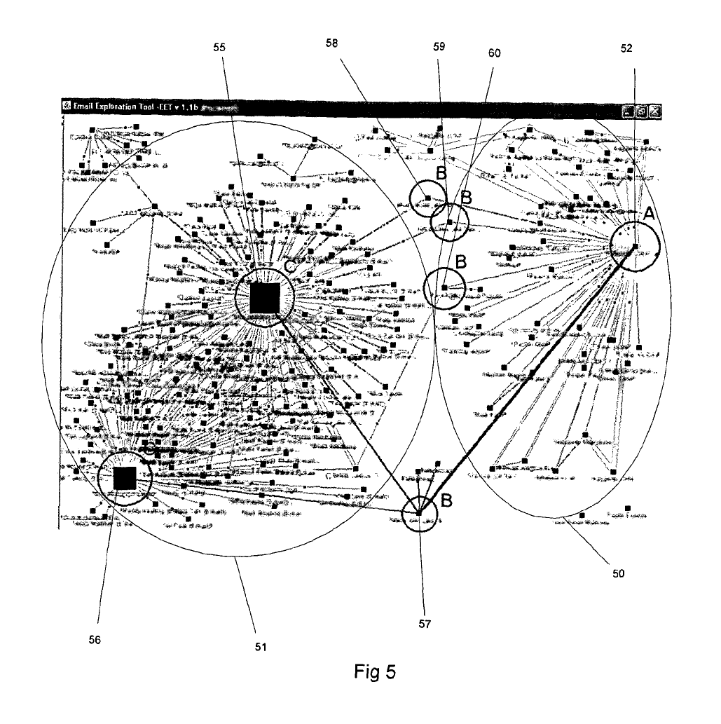

FIG. 5 is a visualisation of a social network generated from emails in a specified folder using the system of FIG. 2.

In the following description, the term social network is used to refer to a group of individuals who communicate with each other, while the term computer network refers to two or more computers connected together so as to allow for data to be sent between those computers.

FIG. 1 shows three computers 1, 2, 3, each computer being connected to a computer network 4, such as the Internet. Users of the computers 1, 2, 3 can send and receive electronic messages (e-mails) between one another through the computer network 4. Each computer 1, 2, 3 has a respective data storage device 5, 6, 7 (usually a local hard disk drive) for storing emails sent and received by a user of that computer.

Where users of the computers 1, 2, 3 send emails to each other, it may be said that the users of the computers 1, 2, 3 belong to a social network, where each user is an actor within the social network. There is now described a system suitable for processing emails in order to model and analyse social networks. The system analyses emails associated with a particular user so as to model social networks in which the particular user is an actor.

FIG. 2 illustrates the system architecture of an email extraction tool 19 suitable for processing and analysing emails of an actor of interest to facilitate analysis of social networks to which the actor of interest belongs. In the system shown in FIG. 2, a file-reading tool 21 connects to a data storage device 20 in which are stored emails sent and received by the actor of interest. The file-reading tool 21 is adapted to read and process emails stored in the data storage device 20. The data storage device may be, for example, one of the data storage devices 5, 6, 7, or alternatively, emails stored in one of the data storage devices 5, 6, 7 may be copied to the data storage device 20 for analysis by the file-reading tool 21.

The file-reading tool 21 may utilize a plurality of file format parsers 22. Emails sent using a particular email application may be stored in a format which is particular to that email application. Further, an email application may provide options to store emails in a variety of formats at a user's discretion. For example, emails sent using the Microsoft Outlook email application may be stored in the Personal Storage Table (PST) file format. Each file-format parser 22 provides the ability to process emails which are stored in a particular format. For example, one file-format parser 22 may provide suitable tools for processing emails sent and received using the Microsoft Outlook email application, while another file-format parser 22 may provide suitable tools for processing emails sent and received using the Mozilla Thunderbird email application. In this way, a particular file-format parser 22 can be selected by the file reading tool 21 based upon identifying heuristics found in the emails stored in the data storage device 20, which may include, for example, the format of the emails stored in the data storage device 20.

The file-reading tool 21 processes the emails stored in the data storage device 20 to produce a plurality of email and address objects. Each distinct email-address processed by the file-reading tool 21 is output as an address object representing an actor in a social network associated with the actor of interest. Each email object represents a particular email sent between two or more actors. Email and address objects may also be generated from what are known as ‘hidden emails’. A hidden email is an email which is not itself stored as an email in the data storage device 20, but is referred to in an email which is stored in the email address data storage device 20. An example of a hidden email may be an email which has been forwarded to the user of interest by an actor with whom the actor of interest communicates. In the case of forwarded emails, while an actor who receives a forwarded email may not have been a recipient of the original email, the details of the original email (including the contents, sender and recipients) are often quoted in the body of the forwarded email. As such, by identifying text within particular emails wider social networks can be identified.

An example of how the file-reading tool 21 processes emails is now described. In the following example it is assumed that the user of the computer 1 (FIG. 1) is the actor of interest such that the data storage device 20 contains the emails stored in the data storage device 5. It is further assumed that the data storage device 5 contains a single email from the user of the computer 1 addressed to both the user of the computer 2 and the user of the computer 3. In this case, the file-reading tool 21 will process that email to create three address objects, one for the user of the computer 1, one for the user of the computer 2 and one for the user of the computer 3. The file-reading tool 21 will also create two email objects, a first email object indicating an email sent between the user of the computer 1 and the user of the computer 2 and a second email object representing an email set between the user of the computer 1 and the user of the computer 3. In this way, although the emails analysed belong to the user of the computer 1 (the actor of interest) it is possible to determine relationships between other actors (i.e. a relationship between the users of the computers 2 and 3 via the computer 1).

Users of the computers 1, 2, 3 may organise their emails in a hierarchical folder structure, or attach meta-data to the emails, to aid, for example, organisation and retrieval. For example emails may be organised within folders, each folder representing a particular social network to which the user of the corresponding computer 1, 2, 3 belongs. For example, emails may be organised according to whether the emails are sent to or received from a personal social network, a professional social network or an activity-based, or hobby-based, social network. Alternatively, a user may attach descriptive labels, or ‘tags’, to some or all of his emails. For example, an email may be labelled ‘personal’ or ‘work’ etc. The file-reading tool 21 may be arranged to make use of any folder structure or meta-data to allow a user of the email extraction tool 19 to select which emails should be processed. For example, a user of the email extraction tool 19 may instruct the file-reading tool 21 to only process an actor of interest's personal emails.

The email and address objects generated by the file-reading tool 21 are output to a graph-building tool 23. The graph-building tool 23 is adapted to process the email and address objects to generate one or more graphs, each graph representing a social network of actors associated with the actor of interest. The graph-building tool 23 can utilize a plurality of filters 24 to select which emails are included in a particular graph. For example, a user of the email extraction tool 19 may, using an appropriate filter 24, limit emails included in the graph to those sent to or from particular actors, or those containing particular keywords.

The email objects are processed by the graph-building tool to determine connections between particular actors within the social network associated with the actor of interest, and to assign weights to actors and communication paths between those actors.

Each individual actor in a network is represented by a respective node in the graph, while an email sent between two actors is represented by a edge between the nodes representing those actors. A weighting may be applied to each node to indicate the importance of the actor represented by that node within the social network. The weighting applied to a particular actor may take into account a plurality of factors, including, for example, a number of other actors within the social network with .whom the particular actor communicates, or a number of emails associated with the particular actor. Edges between actors may also be weighted according to, for example, a number of messages, or a volume of data, passing between those actors. It will be appreciated that the graphs generated by the graph-building tool 23 may be stored in any appropriate format.

The graph generated by the graph-building tool 22 is output to a visualization tool 25. The visualisation tool 25 processes the received graph and generates a visual representation of that graph. FIG. 3 shows an example of a graph output by the visualisation tool 25.

The visualisation of FIG. 3 is generated from a graph representing emails in a single email folder. It can be seen that each actor within the social network, is represented by a respective node (in the form of a square). The nodes representing actors are arranged in a circle, with a node 31, representing the actor of interest, placed at the centre of the circle. Emails sent between the actors are represented by connecting edges between the nodes representing those actors. While the nodes representing actors are arranged in a circle in FIG. 3, it will be appreciated that the nodes representing actors can be arranged in any appropriate layout, for example, the nodes may be arranged as a circle, a clever circle (wherein important nodes are drawn into the circle rather than remaining on the periphery), or may be arranged randomly on the screen. Once the visualisation of the graph has been drawn to the screen, a user of the email extraction tool 19 can manually manipulate the nodes and add connections between nodes. Any changes made to the visualisation on the screen may be reflected in the underlying graph, to allow the changes to be saved for later viewing.

The way in which nodes are visualised can be configured to be reflect various metrics of interest. For example, the size of a node representing a particular actor can be configured to reflect the quantity of emails received by that actor, the number of other actors receiving emails from the actor, the number of total number of emails sent by that actor, the number of actors sending emails to that actor, or some combination of these factors. It can be seen in the visualisation of FIG. 3 that most of the nodes representing actors are of a generally similar size, indicating that each of the actors is associated with a similar amount of email traffic. However, the node 31 representing the actor of interest is considerably larger than the nodes representing other actors, indicating that, within the social network being shown, the actor of interest is associated with a large portion of email traffic within that social network. The visualisation can also be configured so as to only display actors having certain attributes. Furthermore, the visualisation can make use of established graph-drawing algorithms to lay out the nodes in an intuitive manner, utilising the metrics outlined above. A force-directed algorithm, such as Fruchterman-Reingold, and/or Kamada-Kawai can be used to place the nodes at specific positions on screen. The described algorithms could be utilised to automatically place important (according to their sizing) nodes towards the centre of the visualisation, with their directly connected neighbours arranged in a circle around them.

Several unique email address objects (and therefore, apparently unique actors) may actually be aliases for a single actor in the investigation. These aliases may have been determined externally or through human study of significant email content to, from, or between the apparent email aliases. The tool provides a mechanism by which alias email address objects can be grouped together or otherwise associated. This grouping may be reflected in their visualisation as a single representative alias node, or close visual arrangement of grouped alias nodes.

Further, it may be desirable to only display those actors who have sent (i.e. not only received) emails to other actors within the social network, or those actors who have only received (but not sent) emails from actors within the social network. Such configurations may be useful where, for example, a user of the email extraction tool 19 is particularly interested in those actors who actively disseminate information in a social network, rather than those actors who merely passively receive information from other actors.

In some circumstances, the strength of a relationship between any two actors may be indicated by a volume of emails sent between those actors, which in turn is indicated by the thickness of the edges connecting the nodes representing those actors. Referring again to FIG. 3, it can be seen that an edge 32 connecting the node 31 and a node 30a is of a greater thickness than the edge 33 connecting the node 31 with the node 30b. The relative thickness of the connecting edges 32, 33 indicate that more emails are sent between the actor of interest and the actor represented by the node 30a, than between the actor of interest and the actor represented by the node 30b, and may therefore further indicate that the actor of interest has a stronger social relationship with the actor of interest represented by the node 30a.

The visualisation may further configured to reflect temporal information contained within email messages. For example, it may be desirable to display only those email messages (and thus, the resulting graph) received prior to, during, or after a specified time period. The thickness of edges may be altered depending on the age of messages (for example, edges representing older messages may be displayed with a lesser relative thickness than edges representing newer messages). Further, the visualisation of nodes and connections may be animated to illustrate the development of a network over a specified time period.

It will be appreciated that the metrics and temporal information described above are merely exemplary, and that other methods of filtering, and manipulating the visualisation of nodes and edges will be readily apparent to those skilled in the art.

A control panel to the left of the visualisation is divided into three sections, an email control section 35, a visualization control section 36, and a network statistics section 37.

The email control section 35 comprises an email control button 38, selection of which allows a user of the email extraction tool 19 to select which email files to model as a social network. Selection of new email files to model in turn causes the email file-reading tool 21 to read those emails from the data store 20 and produce email and address objects for the graph-building tool 23. The graph-building tool 23 incorporates the new email and address objects into the graph currently being visualised. The visualisation tool renders the newly added nodes and edges for analysis by a user of the email extraction tool 19.

The email control section 35 further comprises an export button 39 to export the social network model files to a different format, such as the format used in the Pajek network analysis application. A clear network button 40 clears the current social network model from the screen to allow a user to start again, and a quit button 41 exits the email extraction tool 19.

The visualization control section 36 comprises controls to allow a user of the email extraction tool 19 to manipulate the visualisation of the social network. Controls provided by the visualization control section 36 allow a user to draw edges between nodes (for example, if the user is aware of a relationship which has not been modelled by the graph-building tool 23), draw self edges (to indicate emails where a sender has also sent the email to himself), manipulate the thickness of particular edges, toggle a node transparency option, alter the metrics determining node sizing (as discussed above), alter the on-screen layout of the social network model, change the font size and change the number of edge labels which are displayed. An edge between two nodes may be labelled with the ‘subject’ of emails sent between those actors. A user may select individual edge labels from the visualization to view the email represented by that label. It will be appreciated that where actors within a social network exchange a large number of emails, each edge in a graph may represent many emails. Labelling each edge for each of the emails represented by that edge is likely to be detrimental to the analysis of the network model. The edge label control 49 therefore allows a user to select how many edge labels are displayed for each edge. This does not prevent the user from inspecting all the emails represented by this edge. Where a greater number of emails exist than is displayed in the visualised edge label, this is indicated by a visual cue on the edge (such as “Click for more...”). When selecting the edge label, the user is prompted to select the email they wish to view from a pop up list.

The network statistics section 37 provides information about the social network being modelled, such as the total number of emails modelled, the number of actors who send emails within the social network, and the email folder, or file, that is currently being modelled.

As described above, FIG. 3 illustrates a visualisation of a graph generated from a single email folder of an actor of interest. It will be appreciated that the number of actors and communications identified by the file-reading tool 21 will vary depending on the actor of interest, and the environment from which the actor of interest's emails are retrieved, for example a home computer or computer at the actor of interest's place of employment. In general, where the actor of interest's emails are retrieved from a corporate email account, there is likely to be a large number of contacts, identifying both explicit and implicit social networks. The social networks identified will likely include many actors associated with the actor of interest's particular role within the organisation, along with actors representing personal contacts of the actor of interest. Where the actor of interest's emails are retrieved from a home email account, the social networks identified from those emails are likely to include a greater proportion of personal and social contacts.

FIG. 4 illustrates a visualisation of a graph modelling an entire corporate-based email account belonging to an actor of interest. The model illustrated in FIG. 4 comprises nine-hundred-and-seventy-six emails involving six-hundred-and-forty-six actors. A majority of nodes representing the actors of the social network are positioned in a circular ring 40 at the edge of the visualisation, while a node 41 representing the actor of interest is positioned at the centre of the visualisation. Fourteen further actors have been identified as having particular importance within the modelled social network, and nodes representing these actors have been placed inside the main ring of nodes 40 for easy identification by a user of the email extraction tool 19. For example, it can be seen from the relative thickness of an edge 42 connecting a node 43 and the node 41 that the actor represented by the node 43 has strong social links with the actor of interest. It will be appreciated that placement of important actors in the visualisation may be controlled by a user with the visualisation controls 37, or alternatively, the visualisation tool 25 may be configured to identify those actors with high weightings and to position nodes representing those actors away from other nodes.

As described above, folder structures, or meta-data, can provide a starting point for preliminary analysis of an actor of interest's social networks. FIG. 5 is a visualisation of a graph modelling emails and actors from FIG. 4 extracted from the actor of interest's ‘personal’ email folder. The control panel of the visualisation has been hidden in FIG. 5 to provide a larger visual analysis space. Further, in the visualisation of FIG. 5, the size of each node is determined by an amount of emails sent by the actor which is represented by that node. That is, in FIG. 5, the size of a node representing an actor increases as the number of emails sent by that actor increases.

Generally speaking, two distinct subsets 50, 51 of actors are discernable in the visualisation of FIG. 5 and are highlighted by rings surrounding nodes within those subsets. It will be appreciated that the rings surrounding the subsets 50, 51 are merely to aid clarity. The subset 50 occupies the right side of the visualisation, and the subset 51 occupies the left side of the visualisation. The actor of interest is modelled by a node 52 within the subset 50. The subset 50 has fewer actors, with some actors having apparently strong social links with the actor of interest, as indicated by the relatively thick connecting edges between some nodes of the subset 50 and the node 52. The apparent strength of the social links between the actors in the subset 50 suggests that the actors in the subset 50 are socially close to the actor of interest. Such analysis may be useful where a user of the email extraction tool 19 is attempting to identify actors in a network who may be able to provide information about the actor of interest.

The subset 51 comprises a large volume of traffic sent from two actors, represented by nodes 55, 56 to a large number of other actors, as can be seen by the relative sizes of the nodes 55, 56. The sizing of nodes 55, 56 identifies those actors as disseminators of information within the social network.

Four bridge nodes 57 to 60 occupy both the subsets 50, 51 and therefore connect the nodes representing the disseminators 55, 56 and the actor of interest 52. This position within the model identifies the actors represented by the nodes 57 to 60 as having an important relationship with the actor of interest, in that the actors represented by the bridge nodes 57 to 60 choose whether to forward emails which they receive from the disseminators 55, 56. Again, this may be useful to a user of the email extraction tool in determining key actors to approach for further information. It will also be appreciated that, as there are no edges directly connecting the node 52 with the nodes 55, 56, the information about the subset 51 is derived from emails forwarded to the actor of interest by the bridge nodes 57 to 60 (i.e. so called hidden emails).

Other forms of communication can also be modelled using methods described above. For example, telephones (both landlines and mobile telephones) often store a record of calls received at and made from that telephone in a ‘call history’. A call history of an actor of interest may be analysed to produce a graph modelling a further social network associated with an actor of interest. Similarly, telephones which configured to allow the sending and receiving of textual messages (such as Simple Message Service (SMS) messages) or multimedia messages (such as Multimedia Message Service (MMS) messages) are often configured to store any messages sent by and received at that telephone. Analysis of such stored messages can be performed to produce models of further social networks associated with an actor of interest. That is, while the embodiments described above have described an actor-centric approach to network analysis, a provider centric approach may be used to derive a larger network of relationships between actors in a social network. While such an approach can provide a wider ranging source of data for analysis which may be useful in some circumstances, it may result in analysis of a large number of links of little or no real interest. As such, it may be preferable to employ an actor-centric approach so as to better control the links which are modelled.

Further, organisations providing communication infrastructure (such as telecommunications network providers, Internet Service Providers etc), may store more information about communications sent and received by their customers. Embodiments of the present invention may therefore use information stored by communication infrastructure providers for analysis.

Further examples of suitable communications are messages sent through an internal messaging system of what are generally termed ‘social networking websites’ such as Facebook and MySpace. It will be appreciated that any communication media which provides a record of past communications, and the actors involved in those communications, may be used to create a social network model according to embodiments of the present invention.

Embodiments of the present invention further allow for network models generated from disparate communication media (such as emails, telephone call records and textual or multimedia phone messaging) to be combined into a single network model. Alternatively, each disparate communication media may be analysed to produce a respective network model, and each respective network model may be overlaid in a single visualisation. For example, email communications involving an actor of interest may be analysed to identify, and create a model of, a first social network of which the actor of interest is a member. Further, the actor of interest's telephone records may be analysed to create a second social network model of which the actor of interest is a member. Both the model created from emails, and the model created from telephone records can then be combined to create a model of a social network which incorporates analysis of both communication media.

1-31. (canceled)

32. A computer implemented method for analysing communication between a plurality of individuals, the method comprising:
reading data representing communications involving a first individual from a data store; and
displaying a representation of the communications between the first individual and a plurality of other individuals, wherein, in said representation, each individual is represented by a node and communication between individuals is represented by a link between nodes.

33. A method according to claim 32, wherein each node is represented in a manner determined by a number of communications in which the individual represented by that node is involved.

34. A method according to claim 33, wherein the number of communications is a number of communications which were initiated by an individual other than the individual represented by the respective node.

35. A method according to claim 33, wherein the number of communications is a number of communications initiated by the individual represented by the respective node.

36. A method according to claim 32, wherein a node is represented in a manner determined by an amount of data present in communications in which the individual represented by that node is involved.

37. A method according to claim 32, wherein a node is represented in a manner determined by a number of individuals with whom the individual represented by that node communicates.

38. A method according to claim 32, wherein a link between two nodes is represented to indicate a number of communications between individuals represented by those two nodes.

39. A method according to claim 32, further comprising:
obtaining data representing communication involving each of said plurality of individuals; and
displaying a network of the communications between said plurality of individuals, wherein each individual is represented by a node and communication between individuals is represented by a link between nodes.

40. A method according to claim 39, wherein displaying a network comprises displaying only nodes representing individuals who have initiated a communication with at least one other of said plurality of individuals.

41. A method according to claim 39, wherein displaying a network comprises displaying only those nodes representing individuals who are associated with a communication initiated by at least one other of said plurality of individuals.

42. A method according to claim 32, wherein said communications are selected from the group comprising emails, telephone communications, simple messaging service messages, multimedia messaging service messages and websites' internal messaging services.

43. A method according to claim 32, wherein reading data comprises reading emails from a data store storing emails.

44. A method according to claim 43, further comprising processing each of said emails to generate a email objects and address objects, each of said address objects representing a respective email address and each of said email objects representing an email sent between two of said respective email addresses;
wherein said nodes represent said address objects and said links between nodes represent said email objects.

45. A method according to claim 43, wherein at least one of said emails in said data store comprises a reference to a further email, the further email not itself being stored in said data store, and the reference identifying a sender and receiver of said further email; and
wherein processing each of said emails further comprises processing said further emails.

46. A method according to claim 45, wherein the reference comprises textual data identifying the sender and the receiver of the further email.

47. A method for analysing communication between a plurality of individuals, the method comprising:
analysing communication between the plurality of individuals using a first communication platform to generate first data;
analysing communication between the plurality of individuals using a second communication platform to generate second data; and
generating third data based upon said first data and said second data, said third data indicating relationships between said plurality of individuals.

48. A method according to claim 47, further comprising:
generating a visualisation of said third data wherein each individual of said plurality of individuals is represented by a node and communication between individuals is represented by a link between nodes; and
displaying said visualisation.

49. A method according to claim 48, wherein a node is represented in a manner determined by a number of communications in which the individual represented by that node is involved.

50. A method according to claim 49, wherein the number of communications is a number of communications is which the individual represented by that node is involved which were initiated by another of said plurality individuals.

51. A method according to claim 49, wherein the number of communications is a number of communications initiated by that individual.

52. A method according to claim 48, wherein representation of a node is determined by an amount of data present in communications in which the individual represented by that node is involved.

53. A method according to claim 49, wherein representation of a node is determined by a number of individuals with whom the individual represented by that node communicates.

54. A method according to claim 48, wherein representation of a link between two nodes indicates a number of communications between individuals represented by those nodes.

55. A method according to claim 47, wherein said third data comprises data indicating relationships only between individuals who have initiated communications with at least one other of said plurality of individuals.

56. A method according to claim 47, wherein said third data comprises data indicating relationships only between individuals who are involved in communications initiated by at least one other of said plurality of individuals.

57. A method according to claim 47, wherein said first communication platform is selected from the group comprising email, telephone communication, simple messaging service, multimedia messaging service, and websites' internal messaging platforms.

58. A method according to claim 47, wherein said second communication platform is selected from the group comprising email, telephone, simple messaging service, multimedia messaging service and websites' internal messaging platforms.

59. A method according to claims 48, wherein said first and second communication platforms are different communication platforms.

60. A computer program comprising computer readable instructions configured to cause a computer to carry out a method according to claim 32.

61. A computer readable medium carrying a computer program according to claim 60.

62. A computer apparatus analysing communication between a plurality of individuals:
a memory storing processor readable instructions; and
a processor arranged to read and execute instructions stored in said memory;
wherein said processor readable instructions comprise instructions arranged to control the computer to carry out a method according to claim 32.
